(19) United States
(12) Patent Application Publication
(10) Pub. No.: US 2010/0131535 A1
(43) Pub. Date: May 27, 2010

(54) GEOGRAPHIC LOCATION IDENTIFY SYSTEM WITH OPEN-TYPE IDENTIFIER AND METHOD FOR GENERATING THE IDENTIFIER

(76) Inventor: Hsin-Chang Lin, Taipei City (TW)

Correspondence Address: Muncy, Geissler, Olds & Lowe, PLLC, 4000 Legato Road, Suite 310, FAIRFAX, VA, 22033, US

(21) Appl. No.: 12/622,968

(22) Filed: Nov. 20, 2009

(30) Foreign Application Priority Data
Nov. 21, 2008 (TW) 97145058

(51) Int. Cl. G06F 17/30; G06F 3/048

(52) U.S. Cl. 707/758; 715/764; 707/E17.009

(57) ABSTRACT

Disclosed is a geographic location identify system with open-type identifier, and further a related method for generating the identifier. One object of the geographic location identify system is to depict information of a spot on a geographic space with open-type identifier that is user-customized with privileged-setting. The system preferably includes a data processing means for processing geographic data by a computer system, and a network connecting means for connecting to plural terminal computers. After a user inputs an open-type geographic location identifier, a means for encoding/decoding is to encode or decode the identifier. A database unit is further included to store the identifier data after encoding. A comparing means is used to compare the identifier data with the input identifier, and a visual presentation generating means is to generate an electronic map, and through the database unit providing the spot related information, based on the user's request.

### BACKGROUND OF THE INVENTION

1. Field of the Invention

The present invention generally relates to an open-type geographic location identify system, and a method for generating an identifier therefor, more particularly, the system provides an electronic map, and a spot thereon has an identifier having individualized information, privileged setting, and/or spatial relation.

2. Description of Related Art

According to the well-known network services, electronic map becomes a very useful tool for providing a search service on map and the addresses. Additionally, the service applicable on the electronic map includes searching a landmark related to a specific address, a scenic spot, a restaurant, a hospital, or a plurality of recreational facilities. Those services are based on the searching results as users make the search using keywords or addresses. Reference is made to FIG. 1A showing the schematic diagram of the conventional electronic map.

This figure schematically shows the conventional electronic map which requires searching by a user filling keywords in a keyword field 101 such as a road name, a scenic spot, or a precise address. After that, the electronic map will reveal the location. Where the keyword corresponds to a specific location recorded in a map database, and a determined range of the map 103 is shown. Next, a destination spot 105 will be marked on the map 103.

The service of address searching shown in the diagram of FIG. 1A is provided for the user requesting a normal searching of a specific address, but not any individual service for the user's personal need.

FIG. 1B shows a web page serving a map with image of the conventional art. It is combined with the map and the related pictures in order to provide the additional information. According to the recent announced services, an electronic map with marked image has been provided according to some known web sites regarding community services. That means the user may upload his taken picture 107, and designate a location where the picture 107 is taken for further map searching by others. Therefore, it is not only to see the location, but also acknowledge the location's situation through the pictures taken by the users. After simply clicking the mouse button and pointing the location, the related pictures are shown up.

However, it is still difficult to orally share the location on the map with others in the conventional art. The conventional art easily confuses people and makes the information hard to memorize. On the one hand, the keyword searching merely finds the related locations, but not able to designate a certain place. Even though the well-known universal address plays the similar idea, only part of the geographic space is included.

The URL is usually the way to express a central location of the map. Nevertheless, the URL has restricted space and being limited by network domain over Internet. The current URL used for describing the location is expressed by a single domain linked with the server-recognizable parameters. This type of URL is copious and not easy to identify, memorize and manage the address after searching. It is either not easy to be applicable to other applications.

There are several conventional arts specially used to encode the location information for other applications, but the encoded codes are not idiomatic and recognizable. For example, TOID (Topographic Identifier) practiced in Britain encode the location London as “osgb1000006032892”. It is obvious that the code “osgb1000006032892” is not recognizable and the correlation with London can not clearly be identified. Therefore, a common user may not give a name to the location by himself.

### SUMMARY OF THE INVENTION

To overcome the limitations in the prior art described above, and to overcome other limitations that will become apparent upon reading and understanding the present specification, the present invention discloses a method, apparatus, and article of manufacture for monitoring performance of a parallel database in a computer.

One of the objects of the present invention is to provide a geographic location identify system and a method for the system. By means of a user authentication, the user can add the individual information to the information of open-type identifier after transformation. Therefore, the identifier corresponds to various messages. If a privilege setting scheme is further incorporated, it is able to restrict any other user searching the identifier-related information made by the privileged user.

According to the preferred embodiment of the open-type geographic location identify system of the present invention, a data processing means is introduced to process the data transmitted or received by the open-type geographic location identify system. A network connecting means is further used to link network, and one or more remote terminal computers are able to connect to the open-type geographic location identify system by the network connecting means. Therefore, the geographic location identify system is accessed.

After the related user inputs any data, an identifier coding means is used to encode or decode the received location-related data. The encoded identifier is stored in a database unit of the geographic location identify system, more particularly the database unit includes a geographic information recording means, a location recording means used for recording the location, and a user data recording means used for recording data of user authentication and privileged user.

The mentioned geographic location identify system has a comparison means used for comparing the identifier processed by identifier coding means and the identifier stored in the database unit. According to a user's request, a visual presentation generating means is used to generate an electronic map image based on the information recorded in the identifier. In connection with the database unit, the location-related information is also provided.

In the embodiment of the claimed method, the open-type identifier is divided into two types including a spot positioning tag and a spot naming tag. The method for generating location identifier is firstly to perform a user authentication procedure. After the user successfully logging on the system, the system receives the coordinate data transformable to system coordinates. The mentioned transformable coordinate data is inputted directly by the user, such as a series of codes in compliance with a specific format, or a set of coordinates. Alternatively, the codes can be generated by the system when a provided user interface guides the user to input the related information regarding the location to be encoded. The user interface is preferably a map interface provided for users inputting keywords for searching, or controlling a cursor for selecting a location to be encoded. After the system receives the information, the information will be transformed to the system coordinates. The information is encoded and stored in a database.

One further object of the present invention is to provide the system, by which the users can deliver the open-type identifier to others. After steps of decoding, comparing with the identifier in the database, and authenticating, the receivers can access the information in identifier according to the privileged setting therein. Based on the privileged setting, public or individual information is displayed. An electronic platform to the recognizable identifier is established for people's convenience and functioning exchangeable information. It is featured that the applications related to the locations on the electronic map will be widespread.

According to the above-mentioned embodiment, following list shows the features provided by the open-type geographic location identify system in accordance with the present invention:

First, the coding of the open-type identifier is not restricted by the common universal address.

Second, the open-type identifier can be easily spread over the paper, electronic, or on-the-air media since it is text-type information.

Third, the open type structure makes users free to give it a name.

Fourth, the function of user authentication make different users with different privileges for accessing the location, the private information can be collected by the privileged users, and the privileged information can be open to a certain community.

Fifth, the spot positioning tag still adopt the common hierarchical naming standard in accordance with the usual practice, and the people easily memorizes and manages the locations.

Sixth, the spot naming tag is integrated with the name (user name or subject) configured in the system, and the user-defined name (name of spot or subject of event) for describing the location, and the meaningful name makes the location easy to memorize and manage.

Seventh, the spot naming tag is not necessary to link a specific location, and the tag needs not to be changed when the location changes, but merely modify the link.

Eighth, it is featured that it's different from the URL on the conventional electronic map since the conventional way is restricted by network domain which is irrelevant to the geographic relation, and unfriendly due to the series of codes.

Ninth, the function of recognition of the claimed system is not only adapted to the geographic space of real world, but also applicable to the virtual space such as game map. Since the naming scheme adopts hierarchical type, the location can be named in compliance with the size of domains, and it spatial relation can be defined by users.

Tenth, it is featured that the identifier directed to a single location is different from the keyword searching, and the identifier can easily lock a specific location.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1A shows a schematic diagram of the electronic map of the conventional art;

FIG. 1B shows a schematic diagram the web page of the e-map with service of pictures of the conventional art;

FIG. 2A is a schematic example of the identifier used to describe the location of the present invention;

FIG. 2B is a schematic example of another identifier incorporated to describe the location of the present invention;

FIG. 2C is a flow chart of encoding a location which is described by spot positioning tags of the identifier in the present invention;

FIG. 2D shows a flow chart encoding a location which is described by spot naming tags of the identifier in accordance with the present invention;

FIG. 3 shows a schematic diagram of the application of the claimed open-type geographic location identify system;

FIG. 4 shows a schematic diagram of the embodiment of the open-type geographic location identify system in accordance with the present invention;

FIG. 5 shows a first embodiment of flow chart of the method for generating an identifier in accordance with the present invention;

FIG. 6 shows a second embodiment of flow chart of the method for generating an identifier in accordance with the present invention;

FIG. 7 is a flow chart illustrating an identifier displaying method of the present invention.

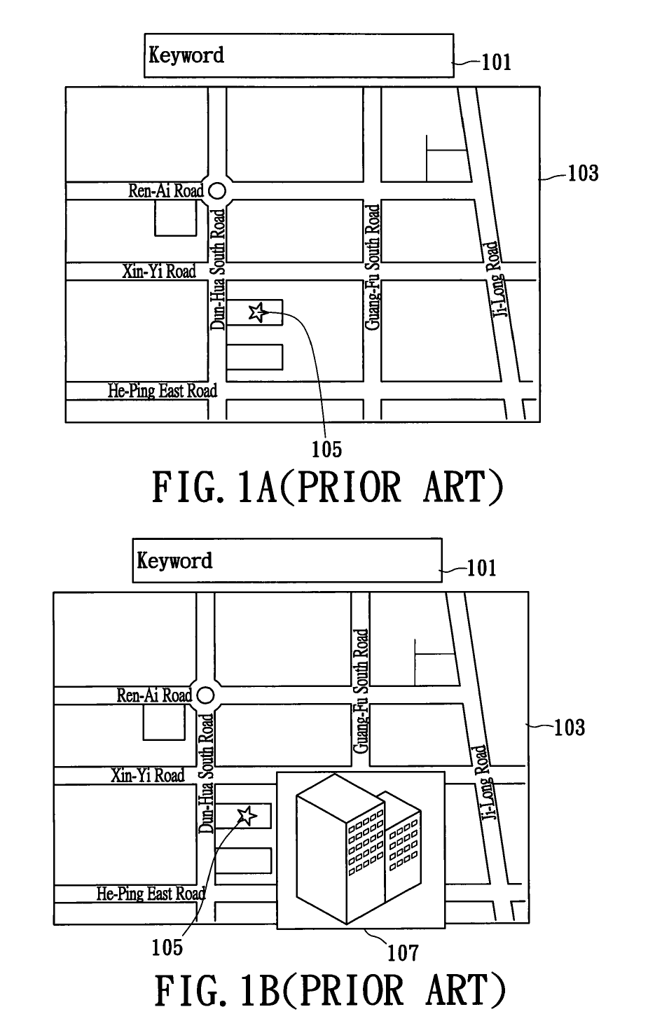

### DETAILED DESCRIPTION OF THE PREFERRED EMBODIMENTS

The invention generally relates to an open-type geographic location identify system and a method for the system. The method includes the method for generating a geographic identifier and the way to display the identifier. The system primarily employs the open-type identifier in compliance with a format, particularly to individualize the name for specific location. The codes related to the identifier are not restricted by the universal address. Furthermore, the open-type identifier can be spread via paper-like, electronic, or broadcasting media since it is text-type information. Still further, users are free to name the identifier, and able to give it a meaningful name rather than the incomprehensible and copious address. The system also provides user authentication, and that makes users having different levels of privileges, such as to manage the private collections, or open to some other restricted users, or to form a network community.

Furthermore, the invention provides the following features:

The mentioned spot positioning tag still adopts the conventional standard naming scheme with hierarchies, and constituted by a plurality of weighted and filtered geographic objects. So that, the tag makes users easily recognize the meaning from the text, and also easy to memorize and make distinct from other geographic locations.

The spot naming tag is in combination with the name of namespace such as user name or subject, and the location-descriptive name such as the location name or event. The tag makes users fast to comprehend, memorize, and distinguish the origin and meaning of the location.

Since the fundamental layer of coordinates of identifier is not revealed to users, the invention can prevent the confusion by the coordinate transformation. As to the sharer of a specific location, the location positioning on the map is merely an approximate coordinates, but the name, opposite spatial position and its description are correct. Therefore the fundamental coordinates on the map can still be modified when the text-type identifier has been created. Furthermore, the identifier can still direct toward to a new set of coordinates even though the surface object is moved.

More, the claimed system provides the individual feature after user authentication. Besides the mentioned privileged setting, the individualized open-type identifier makes the revealed location on the map has various visual styles. For example, since a common place has special meaning to one user, the claimed open-type identifier makes the location have meaningful description rather than the usual electronic map. The geographic location identify system is implemented as a platform for exchanging digital message, and the identifier can be reused in other applications, such as to establish a theme map or a simplified map. Further, other users may add any evaluation on it or set up a sending-and-receiving point for electronic message. It is featured that the visual appearance is not only restricted to the conventional proportional electronic map, but also the theme map, simplified map, 3-D virtual reality, or a diversity of ways to describe the relevant place.

One more application can be used to customize a geographic identifier on a certain range of location via this open-type geographic location identify system. For example, interior of company or any field is a confined place using the customized identifier, and it can advertise the related place. It is applicable that the number of times of quotations or collections of the identifier can be a basis to compute the advertisement fee.

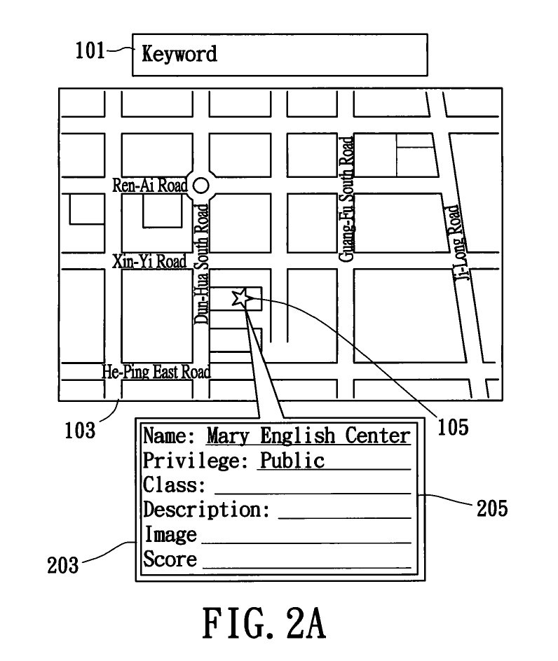

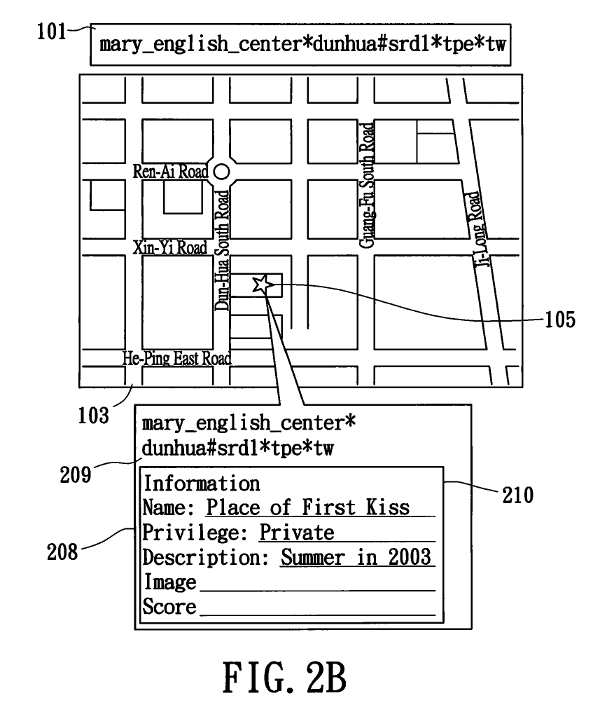

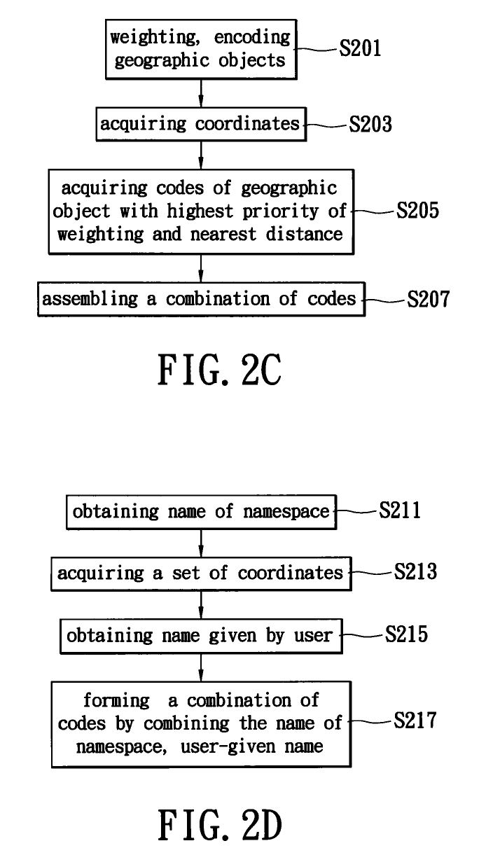

Reference is made to FIG. 2A, a user interface shown on an electronic map is provided. The user interface includes a keyword field 101 for keying in searching text. The lower part of the figure has an electronic map 103. The description of destination spot 105 is an example of the open-type identifier of the present invention.

Firstly in the exemplary example, users can directly use the spot positioning tag generated from coordinates. The authenticated user is permitted to enter the geographic location identify system preferably via a web page, and the user can utilize a cursor to move the map and make a selection of a certain place. Alternatively, the keyword can be used to search the place-to-go, and the provided interface 203 can be further used for filling in related information (205) such as the user-defined name (for example, Mary English Center). The current example is default privileged as public. More, the classification, description, contacts, concerned web sites, or the related pictures are able to be configured by the privileged user. After processing the data through the system, the non-reduplicate spot positioning tag is automatically generated, and sent back to the user. The tag can exemplarily be the shown “mary_english_center*dunhua#srd1*tpe*tw”.

Further reference is made to FIG. 2B showing a way to generate a spot naming tag by a known spot positioning tag. The spot naming tag is necessary to be generated by the spot positioning tag, but can be generated from a set of coordinates or known transformable codes of the coordinates, such as the TOID practiced in Britain.

When the authenticated user (account eric007 for example) enters the system, he may fill the spot positioning tag, such as “mary_english_center*dunhua#srd1*tpe*tw” in the keyword field 101 for text searching. The system will show the numeral 209 indicating relevant information shown in FIG. 2A. The information is public to common users. After that, the user may initiate a function of quotation, in the meantime the system prompt the user filling the relevant information (210) in the interface 208. The relevant information (210) can be the name of the location, such as the “place-of-first-kiss” made by the user, and the related privilege. After the process, the spot naming tag “eric007#place-of-first-kiss” is created.

In light of the above information (210), the user can configure the information related to the location privileged as public information, community-exclusive, or private. It is featured that anyone may not see the information if he didn't have the privilege to read, even impossible to acquire the location designated by the identifier.

More particularly, the hierarchical spot positioning tag can be easily acknowledged from the given name of the open-type identifier, such as “mary_english_center*dunhua#srd1*tpe*tw”. This exemplary spot positioning tag shows a place of “Mary English Center” located at “Dun-Hua South Road section 1” (English address, or in Localized encoding [symbol] ) in Taipei, Taiwan. One more example such as a spot naming tag “eric007#place-of-first-kiss” expresses a place of first kiss made by the user “eric007”, or another exemplary tag “tiffany*5av*mhtn*ny” is for Tiffany Company located at 5^{th} Avenue in New York City, those are comprehensible, distinct and easy to be memorized.

The above-mentioned codes are composed of the texts and the spaced symbols, such as “#”, “*”, “@”, “:”, and “_”. The codes can be easily reproduced and utilized. The procedure of coding the spot positioning tag can refer the following description in FIG. 2C:

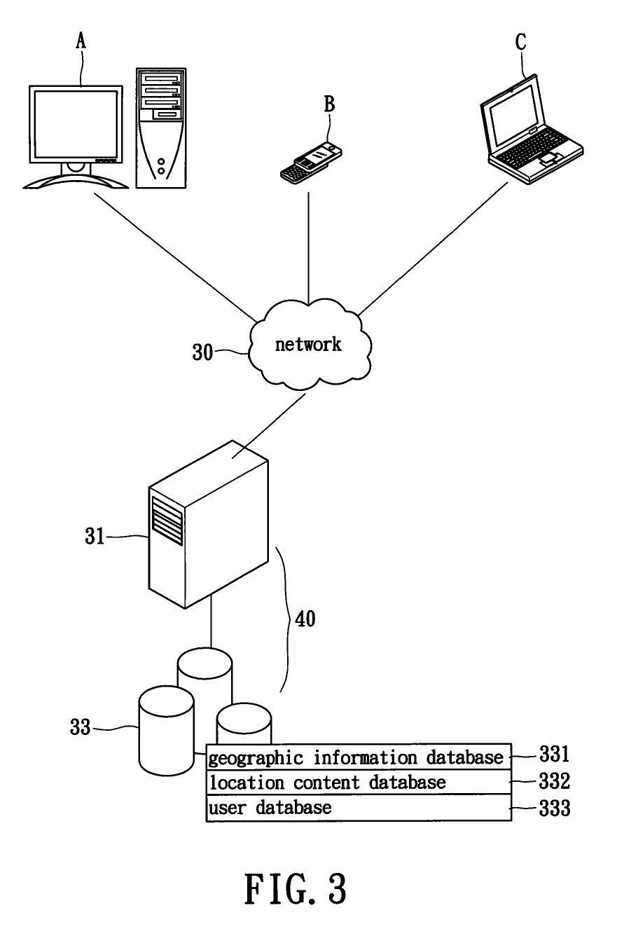

1. In accordance with the geographic information in the database unit, referring to FIG. 3, the geographic objects are weighted and encoded by referring to their priorities (step S201). For example, “NTU” is abbreviated from National Taiwan University, and “TaiDa” (or Chinese [symbol] ) is another abbreviation in Chinese; “TPE101” and [symbol] 101” (Chinese) are for Taipei 101 Tower; and both “Roosevelt Road 1” (or [symbol] ) and “roosevelt#rd1” represent the section 1 at Roosevelt Road;

2. The system acquires a coordinate system (step S203);

3. In center of the coordinates related to a location, it is to acquire the codes of geographic object with the highest priority of weighting and nearest distance (step S205);

4. The codes has priority of landmark, however, the nearest road with high weighting is used as the codes if there is no any high-weighting landmark;

5. At last, a combination of codes is assembled based on the priority of weightings (step S207). For example, spot abbreviation plus high-weighting surface object or road code plus city or county code plus province or state code plus national code. The further examples are:

Example 1, the geographic objects are spaced by “#” and “*”, such as “mcdonalds*xinsheng#srd2*tpe*tw” or in Chinese

[symbol]

[symbol]

Example 2, the individualized information is added to coding, such as the order of “Mary1234@school*xinsheng#srd2*tpe*tw” is presented as nationality (tw), city (tpe), road (rd), name of road (xinshengs), location (school) and the individualized information (Mary1234).

The procedure of coding the spot naming tag is referred to FIG. 2D. The spot naming tag may introduces the mentioned spot positioning tag, and it makes the same place can have different description for featuring the individualization. The procedure has:

Step 1, it is to obtain the name of namespace from the spot naming tag. For example, the location is the place to hold activities, and the subject can be “million-people road running” or “star war” as a game's title. The default namespace can be the user account (step S211);

Step 2, it is to acquire a set of coordinates (step S213);

Step 3, a name given by the user is obtained (step S215);

Step 4, a combination of codes is formed by combining the name of namespace, user-given name, and location (step S217).

Example 3, the code such as “michael@school” which is an individualized spot naming tag named after an alias of the logon user and the location. Therefore, the individual spot naming tag can apply to any privileged user who may permit other users or community to access the same tag.

Example 4, the code such as “userID:locationName” wherein the included objects are spaced by “:”.

Example 5, the code such as “million-people-marathon::first-aid-station” wherein the included objects are spaced by “::”. The namespace is named after “million-people marathon”, and the location is “first-aid station”.

Further reference is made in FIG. 3 showing a schematic diagram of the embodiment of open-type geographic location identify system. The shown geographic location identify system 40 primarily includes a server 31 and database 33, and preferably being implemented by a computer system. The terminal users, such as the shown terminal computers A, B, C, make connection to the system 40 over network 30.

In a preferred embodiment, the user utilizes the terminal computers A, B, C to enter an electronic-map interface provided by the system 40 via execution of specific software or a web browser. Keywords in the interface are used to search a location or alternatively the target spot can be found by directly dragging the objects on the map. At this moment, the system provides the interface for users filling data, and the user may follow the prompts to fill the individualized information, and set the relevant privileged setting. The system 40 then transmits the data, which is exchangeable as coordinates, and the related information back to server 31. After that, a geographic identifier is generated by an encode/decode program in compliance with a specific coding format, and further transmitted to the user.

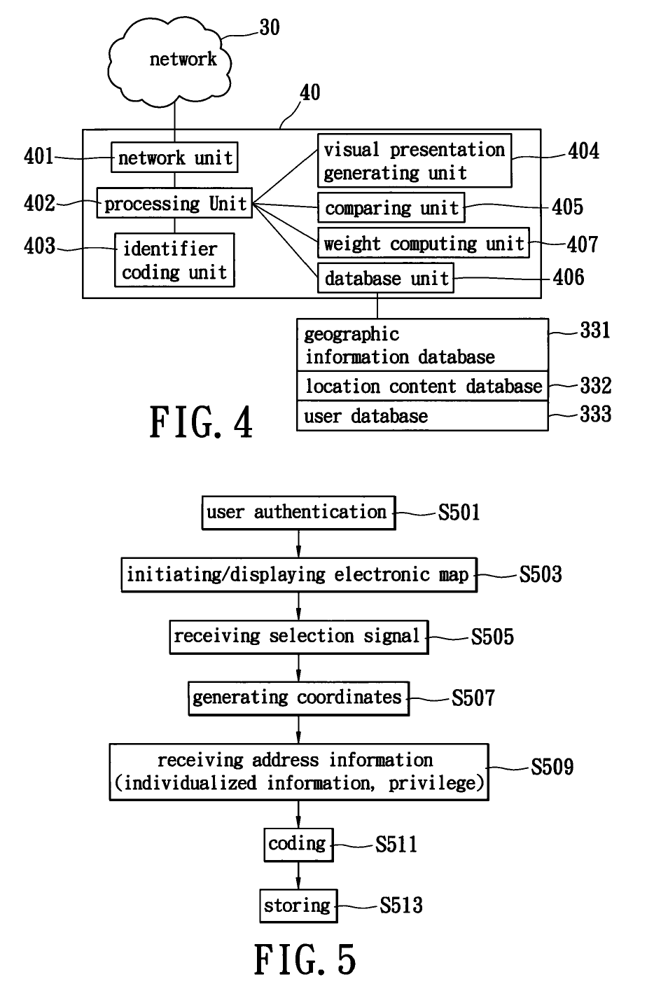

A database 33 in the geographic location identify system 40 has a geographic information database 331, a location content database 332, and a user database 333. The database 33 is used to manage the encoded identifiers created by the users. FIG. 4 shows some embodiments of the identifiers.

The diagram of the geographic location identify system shown in FIG. 4 includes a network unit 401, a processing unit 402, an identifier coding unit 403, a visual presentation generating unit 404, a comparing unit 405, a database unit 406, and a weight computing unit 407. Furthermore, the database unit 406 includes the geographic information database 331, the location content database 332, and the user database 333.

The geographic location identify system 40 is preferably implemented as a computer system embodying a server, where the computer system has the processing unit 402 for processing data transmitted or received by the open-type geographic location identify system 40. The data includes the code of identifier, network packets, the messages interchanged among system units, and the statistics and classification of the location information.

The geographic location identify system 40 primarily provides services to remote users over network 30, in which a network unit 401 is employed by the system 40 to connect the network 30. Therefore, one or more remote terminal computers such as handheld devices or e-paper devices, are linked, and thereby to transmit the data for performing relevant services.

A remote user may input the information related a location through a user interface (UI) generated by the web browser or specific program over the network 30. After that, system 40 uses an identifier coding unit 403 to encode or decode the received or transmitted location information, and generates an identifier. More particularly, the identifier generated by the system 40 includes the digital data used for describing a designated location. Further, the individualized information and privilege setting can be added in the identifier during the time of coding via the interface, or even the spatial relation used for describing the location is added. In combination with diversity of information, the open-type identifier is formed. Each geographic object recorded in the identifier is weighted according to the priority of importance of the objects. The weights are calculated by a weight computing unit 407. One of the ways to configure the weight of location is referring to determine the times to be quoted by others, and the frequency of quotation is multiplied by users' evaluation. A weight of road is calculated by referring to type of the road or the number of identifiers in accordance with one embodiment of the invention.

One more feature is to utilize the integration of relational database in the geographic location identify system 40. Particularly, a data correlation including one or more geographic icons, associated individual information, privileged setting, and the related spatial relation are established in the identifier. Therefore, the individualization generally collocates with the mentioned interconnected information, the electronic map with special visual style, simplified map, or 3-D virtual reality.

The described encoded identifiers are stored in the database unit 406 of the system 40. The database unit 406 especially includes geographic information database 331 having the diversity of information of electronic map. In accordance with the selection made by any user, the related objects in the database unit 406 are combined to form the location-related static or moving pictorial descriptions. More, the database unit 406 includes a namespace of the spot naming tag, and the information recorded by the user in the location content database 332. It is essentially to record the individualized information having privileged setting of browsing in the identifier configured by the user through an interface, and to generate the encoded content afterward. The database unit 406 further includes the user's certified data and the user database 333 having user's privilege. By which, the system can determine the privilege to access the system of the logon user or any anonymous user. More particularly, it is to determine the privilege of the open-type identifier as decoding or encoding.

The geographic location identify system 40 further has a comparing unit 405, which is primarily used to compare the identifier processed by the identifier coding unit 403 with the identifier stored in the database unit 406. A visual presentation generating unit 404 is further included in the system 40, by which the system 40 can follow the user's request or/and the result of comparison to generate the static or moving pictorial description in accordance with the identifier.

Reference is made to FIG. 5 showing a flow chart of the method for generating the identifier. In the beginning in step 501, a user authentication procedure is firstly processed. The users may utilize a diversity of terminal devices to link a server system with the geographic location identify system over network. After successfully logging on the system, the system will initiate to display an interface of an electronic map (step S503). The geographic location identify system may transfer the previous screen appearance in compliance with the previous logon setting, or a default screen to the user, such as, but not limited to, the default picture, welcome screen or system announcement.

Next, in step S505, the geographic location identify system receives the signals of selection of location made by the user through the interface. For example, the user uses a mouse cursor to drag the map to a position, or utilizes keyword including landmark, name of road, or complete or partial address to search the place to be found. Alternatively, the user also can click and select the existed identifier to find the location. Preferably, the quotation of the existed identifier can be used to generate new spot naming tag. After the system receives the selection signal made by the user via the server or a terminal program processing unit, a set of coordinates related to the location can be generated accordingly (step S507).

The geographic location identify system will create an interface and display it on the terminal computer via web browser or proprietary software. By which, the system guides the user to input information, such as the information related to the identifier, by following the prompts on the interface. The information preferably can be the location name given by the user, the individualized description, the way to contact the place, or its address, in particular, can be a topological relation including up, down, left or right side positioning the location in order to distinguish from the near places. Furthermore, it is featured that the user can set the privilege for others view the individualized information. After that, the coordinates and the associated digital data and information are transmitted back to the system via the user end browser or any specific software (step S509).

Next, the geographic location identify system receives the location information, which at least includes the information related to the location, the individualized information created by the user, and its privileged setting. The system then uses an identifier coding unit to encode the location information in step S511. After generating an open-type identifier, the identifier is stored to the database unit (step S513).

The spot positioning tag of the identifier is composed of a plurality of weighted and filtered geographic objects. By means of hierarchical naming, the address of location can be described. Further, the individualized naming and the geographic objects are permuted in accordance with a hierarchical order. One or more of the spacing symbols including “_”, “#”, “*”, “@” and “:” are used to space the naming or objects. The spot naming tag of identifier is composed of the name of namespace and the name given by the user, including subject text and descriptive text, and the spacing symbols. It is noted that the user can transmit the open-type address to others, and the system can determine the receiver's privilege by decoding, encoding, comparing the identifier in database. At last, the distinct information relating the location is displayed and generated according to the user's privilege and the privileged setting in the identifier.

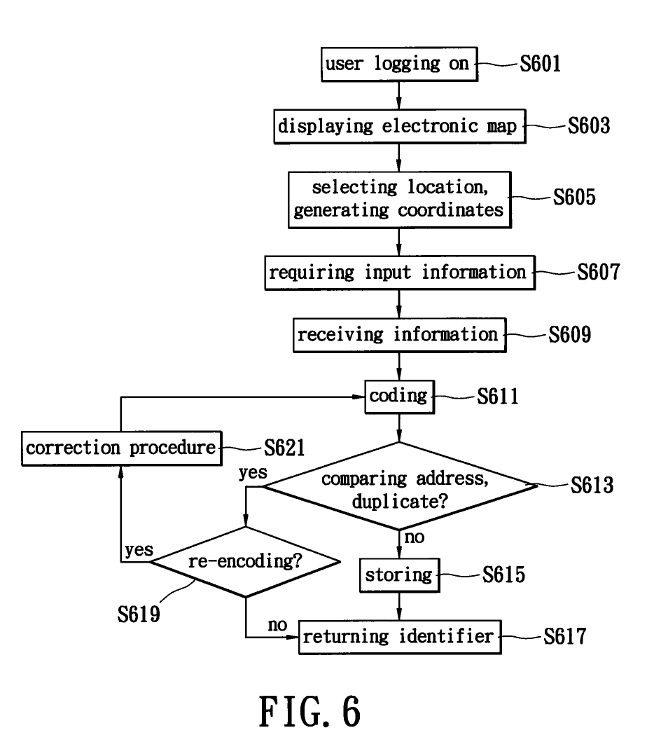

FIG. 6 illustrates a flow chart of another embodiment of the method for generating the open-type identifier. Similarly, the user need to log on the geographic location identify system (step S601). After an initializing process, the system displays an electronic map through a web browser or a proprietary program (step S603). The user then makes a selection of location on the map via a user interface. The server or any terminal of the system receives the selection and generates related coordinates (step S605).

After that, the geographic location identify system guides the user to fill the relevant information in the interface through the browser (step S607), including the various individualized information or/and privileged setting. The geographic location identify system then receives the location information in step S609. Next, the system encodes the coordinates of location and the relevant information which are sent to a spot address encoding unit, and generates the identifier (step S611). In the meantime, the geographic location identify system uses a comparing unit to determine whether the location information is duplicate of encoding from the coordinates and relevant information (step S613). One of the purposes is to exclude the duplicated data.

If it is determined that there is not duplicated (no), it means that the encoded identifier has been stored in the database unit (step S615). Next, the system will return the identifier in step 5617.

If it is determined that the database unit exists the similar or identical coding to the location (yes), the geographic location identify system will send back an analogous address to the user and prompt the user to decide whether the location needs to be re-encoded (step S619). At this step, it is primarily to inquire whether the user needs to use a new code to describe the same location. If it's not required to re-coding (branch “no”), the method gives up the coding and sends back an affirmative signal (step S617). If it is required to re-code the information (branch “yes”), the geographic location identify system enters a correction procedure (step S621). In this correction procedure, if the location has a duplicate data, the system asks for the user inputting the related spatial relation. In one embodiment, the server requires the user confine a spatial relation including left, right, up and down side under this situation. That is to add the spatial relation on the same location for distinguishing the previous spatial relation stored in the database unit. If it has a duplicate name at the same section, the system reminds the user to rename, or add some discernible strings on a free-naming space according to the privilege and namespace in compliance with the rule in the correction procedure. For example, the code “eric007#hospital” or “eric007# [symbol] is automatically renamed as “eric007#hospital_{—}01” or “eric007# [symbol] _{—}01”; the code “711” *Chung-Hsiao-East-Road2*Taipei*Taiwan” or “711 [symbol] [symbol] ” is changed to “711_{—}03*Chung Hsiao-East-Road2*Taipei*Taiwan” or 711_{—}03 [symbol] [symbol] . After that, the method goes to perform the comparison and storing process.

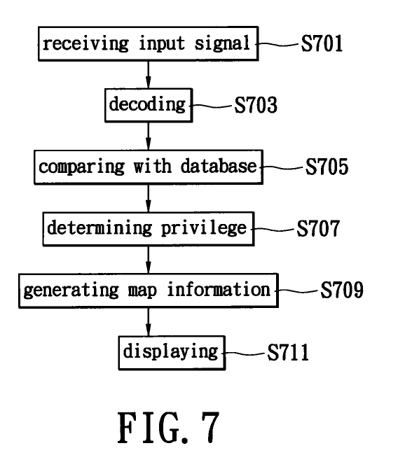

Following the mentioned method for generating the identifier, the FIG. 7 further shows the flow chart of the method for displaying the open-type identifier. It is featured that the text-type identifier can be transmitted easily by broadcasting via media, or among users. The user can input a known open-type identifier to transmit the spot information via the geographic location identify system.

After the geographic location identify system links to the remote users, the system will receive the user-inputted identifier, and send back and being an address of location displayed on a browser or specific software (step S701). If the user successfully logs on the system, the system then verifies the user's privilege and accordingly allows the user to enter the system. Alternatively, if an anonymous user is verified, the user is privileged as public and allowed to access the public information of the system.

In the next step S703, the identifier can be attached with the individualized information or/and privileged setting. As the geographic location identify system receives the identifier, the method operates decoding on the hierarchical open-type identifier in accordance with the weights of geographic objects. After that, the geographic coordinates and related information are obtained. Those data is compared with the information in the database (step S705). The step in the method is then to read the inside individualized information and privileged setting. In the meantime, the method is to determine the geographic information, content and user's privilege, and make the geographic location identify system to check whether the identifier is conformed to the user's privilege or not (step S707). The related map and information are generated in accordance with the privilege in step S709). The step S711 in the method is then to display the visual static or moving image for pictorially describing the spot is formed in combination in accordance with a user's selection.

In the summation of above description, one object of the geographic location identify system and the related method is to generate and transmit the individualized information and privilege related to a spot information by a text-type geographic identifier. The hierarchical naming rule and the coding are note limited to the normal scheme. It is featured that the invention provides an aspect of user authentication, and makes the user has different privilege in accordance with the account. It can create the individualized feature of any spot information.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. An open-type geographic location identify system, which incorporates an open-type identifier carries individualized and privileged setting information to depict a spot, wherein the system at least comprises:
(a) a data processing means, processing data transmitted or received by the open-type geographic location identify system;
(b) a network connecting means, wherein the system uses the network connecting means links to a network, and one or more terminal computers link to the system via the network by the same means, thereby to transmit the data processed by the data processing means;
(c) an identifier coding means applicable to encode or decode location information received or transmitted by the open-type geographic location identify system for generating electronic data depicting a specific spot and the open-type identifier;
(d) a database unit storing the open-type identifier decoded by the identifier coding means in the geographic location identify system, wherein the database unit includes:
(i) a geographic information database, recording information regarding an electronic map, in which a static or moving image for pictorially describing the spot is formed in combination in accordance with a user's selection;
(ii) a location content database, recording the individualized information inputted by the user via an interface, and further configuring a browsing privilege for the identifier and providing content after encoding or decoding; and
(iii) a user database, recording each user's privilege for determining the privilege as encoding or decoding the identifier;
(e) a comparison means used for comparing the open-type identifier processed by the identifier coding means and the identifier stored in the database unit; and
(f) a visual presentation generating means, for generating the pictorial description using the static or moving image according to the identifier in accordance with the user's request and result of the comparison means.

2. The system of claim 1, wherein the open-type identifier is a series of codes used to describe the spot by hierarchies.

3. The system of claim 2, wherein the open-type identifier is constituted by a plurality of geographic objects.

4. The system of claim 3, wherein the plurality of geographic objects are weighted based on the objects' priorities, in order to constitute the identifier.

5. The system of claim 4, wherein the geographic objects are spaced by one or in combination of a plurality of symbols including ‘#’, ‘*’, ‘@’, ‘_’, and ‘:’.

6. The system of claim 4, wherein the plurality of geographic objects and the individualized information are permuted by priorities, and the objects and the individual information are spaced by one or in combination of symbols including ‘#’, “*′, ‘@’, ‘_’ and ‘:’.

7. The system of claim 1, wherein the location information includes electronic data, the information relating to the location, and individual information inputted by the user, which are transformed from an internal coordinates of the open-type geographic location identify system.

8. The system of claim 7, wherein the individualized data is made by the user logging on the geographic location identify system, and a data correlation is established.

9. The system of claim 7, wherein the location information further includes a privileged setting.

10. The system of claim 1, wherein open-type identifier includes a spot positioning tag and a spot naming tag.

11. The system of claim 10, wherein the spot naming tag is constituted by subject text and descriptive text.

12. A method for generating an identifier of an open-type geographic location identify system used to describe a spot by an identifier, wherein the method comprises:
executing a user-authentication procedure;
activating and displaying an electronic-map interface after authentication;
receiving location information at least having spot-related individualized information made by a user, and electronic data transformed from internal coordinates of the geographic location identify system;
encoding the location information;
generating the identifier; and
storing to a database.

13. The method of claim 12, wherein identifier is a series of codes used to describe the spot by hierarchies.

14. The method of claim 13, wherein the identifier is constituted by a plurality of geographic objects.

15. The method of claim 14, wherein the plurality of geographic objects are weighted based on the objects' priorities, in order to constitute the identifier.

16. The method of claim 15, wherein the plurality of geographic objects are permuted according to the weights, and the objects are spaced by one or in combination of symbols including ‘#’, ‘*’, ‘@’, ‘_’ and ‘:’.

17. The method of claim 15, wherein the plurality of geographic objects and the individualized information are permuted based on the weights, and spaced by one or in combination of symbols including ‘#’, ‘*’, ‘@’, ‘_’ and ‘:’.

18. The method of claim 12, wherein when the location information is inputted, a data correlation is formed between the individualized information and privileged setting.

19. The method of claim 12, wherein the open-type identifier includes a spot positioning tag and a spot naming tag.

20. The method of claim 19, wherein the spot naming tag is constituted by subject text and descriptive text.
